(19) United States
(12) Patent Application Publication
(10) Pub. No.: US 2009/0171699 A1
(43) Pub. Date: Jul. 2, 2009

(54) System and Method for Managing a Property

(75) Inventors: John Kenneth Langford, Lakelands New South Wales (AU); Ian Hamilton Perry, Eraring New South Wales (AU)

Correspondence Address: THE WEBB LAW FIRM, P.C., 700 KOPPERS BUILDING, 436 SEVENTH AVENUE, PITTSBURGH, PA, 15219, US

(73) Assignee: LANPER HOLDINGS PTY LIMITED, Toronto NSW (AU)

(21) Appl. No.: 12/297,565

(22) PCT Filed: Apr. 19, 2007
(86) PCT No.: PCT/AU2007/000513

§ 371 Date: Mar. 10, 2009

(30) Foreign Application Priority Data
Apr. 20, 2006 (AU) 2006902068
Sep. 1, 2006 (AU) 2006904798

(51) Int. Cl. G06Q 10/00; G06Q 40/00; G06Q 20/00; G06Q 50/00

(52) U.S. Cl. 705/4; 705/40; 705/30; 705/9; 705/34

(57) ABSTRACT

The present invention provides a system and method for managing rental income. The system includes an interrogation module arranged to secure information regarding a financial institution account controlled by an owner of a property, and verify that rental income has been paid by a tenant of the property. The system is accessible by an agent for the owner of the property.

### FIELD OF THE INVENTION

The present invention relates generally to a system and method for managing a property, and particularly, but not exclusively, to a system for managing the collection of rental income.

### BACKGROUND OF THE INVENTION

It is quite common for property owners who own one or more investment properties (i.e. properties other than their principal place of dwelling), to engage Real Estate Agents or Real Estate Managers to manage the property on their behalf. Generally, a Real Estate Agent/Manager will perform a number of tasks on behalf of the property owner. These tasks may include:
liaising with the Tenant to ensure that rent is paid on time;
choosing and vetting potential tenants;
liaising with third parties to arrange for repair and/or renovation of the property where necessary; and

liaising with the property owner to pass on rental income and inform the owner of any matters that arise (e.g. Tenants leaving, damage to property, etc).

Furthermore, the agent may also have other obligations to the owner, including:
advertising the property for the owner;
the confirmation, supervision, collection and management of security bonds; and
initiating litigation, where required, against tenants, contractors and insurance companies.

As the Real Estate Manager is acting as an Agent for the property owner, the Real Estate Agent is under certain obligations with regard to rental income received from the Tenant of the property. As the income is not “owned” by the Real Estate Agent, the Real Estate Agent is required to set-up a trust account into which the money must be deposited. The trust account is governed by very specific and strict legal rules.

For this reason, the trust account system has inherent problems associated with third party control.

In particular, Agents are required to:
keep records with regard to the receipt of funds;
comply with legislation in respect of trust functions;
make physical payments from funds held in trust and recover trust bank charges;
reconcile the trust ledger to bank statements;
compile an end of month disbursement process;
prepare a statement for the owner;
a preserve an audit trail should any queries be made by the owner and/or other interested third parties; and
engage an independent auditor to provide reports to Statutory Bodies.

These requirements impose an administrative burden on the agent.

The trust account system also has drawbacks for the owner. The owner does not have direct access to their money, but must wait for the Real Estate Agent to release funds. Moreover, in some cases, the Real Estate Agent may release funds for repairs without proper consultation with the owner.

Computerised systems for managing properties have generally been limited to simple applications which do not provide broad functionality.

### SUMMARY OF THE INVENTION

In a first aspect, the present invention provides a system for use in managing rental income, comprising, an interrogation module arranged to receive information regarding a financial institution account controlled by an owner of a property, and verify that rental income has been paid by a tenant of the property, wherein the system is accessible by an agent for the owner of the property.

The system may further include a module arranged to interact with the financial institution account, to withdraw funds from the account. The funds that can be withdrawn from the account may be limited to a predetermined amount.

The system may further include a remote access module arranged to allow access to the system from a remote location.

In one embodiment, the remote access module may allow an agent to access the system.

A report compiling module may be included and be arranged to provide a summary of rental income paid by the tenant to the owner.

In another embodiment, the tenant or the owner may be able to access the summary of the rental income via the remote access module.

The system may also include a database arranged to store information pertaining to the payment of rental income.

A module arranged to interact with the database may also be provided to store information pertaining to the rental property.

An advertising module may be provided and may be arranged to interact with the database to forward information in the database pertaining to the rental property to other users of the system.

There may be provided a scheduling module arranged to prompt a user to perform an action with regard to the rental property.

The scheduling module may be arranged to prompt the user to perform at least one of the activities selected from the group including inspecting the property, paying insurance due on the property, reviewing the rental paid for the property, carrying out scheduled maintenance, and contacting a tenant who has not paid rental income by the due date.

A management module may be arranged to interact with the database to compile reports pertaining to the ongoing management of the property or a plurality of properties.

The system may further comprise a fee management module arranged to deduct a fee from a bank account under the control of the property owner.

The fee management module may apportion a percentage of the fee for the payment of an insurance premium, which may be utilised to pay for a property owner's insurance policy.

The system may also comprise a user interface including a first defined area which is capable of displaying at least one task to be performed by a user, a second defined area which is capable of displaying at least one metric relevant to the users past performance, and a third area which is capable of displaying at least one user control, arranged to allow the user to navigate to vary the information displayed in the first or second area.

The system may be a web server or a standalone application.

In a second aspect, the present invention provides a method of managing rental income utilising a computing system, comprising the steps of accessing a financial institution account controlled by an owner of a property, and verifying that the rental income has been paid by a tenant of the property, whereby the access and verification is performed by an agent of the owner.

In a third aspect, the present invention provides a property management software application arranged, when loaded onto a computing system, in accordance with a second aspect of the system.

In a fourth aspect, the present invention provides a computer readable medium providing a computer program in accordance with a third aspect of the invention.

In a fifth aspect, the present invention provides a user interface for a software application, comprising a first defined area which is capable of displaying at least one task to be performed by a user, a second defined area which is capable of displaying at least one metric relevant to the users past performance, and a third area which is capable of displaying at least one user control, arranged to allow the user to navigate to vary the information displayed in the first or second area.

### DETAILED DESCRIPTION OF THE DRAWINGS

Notwithstanding any other forms which may fall within the scope of the present invention, a preferred embodiment will now be described, by way of example only, with reference to the accompanying drawings in which:

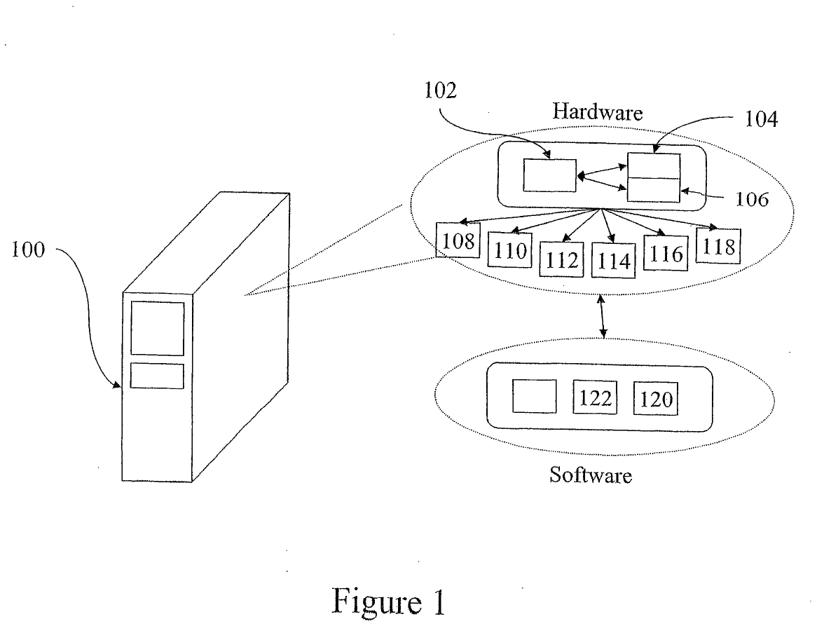

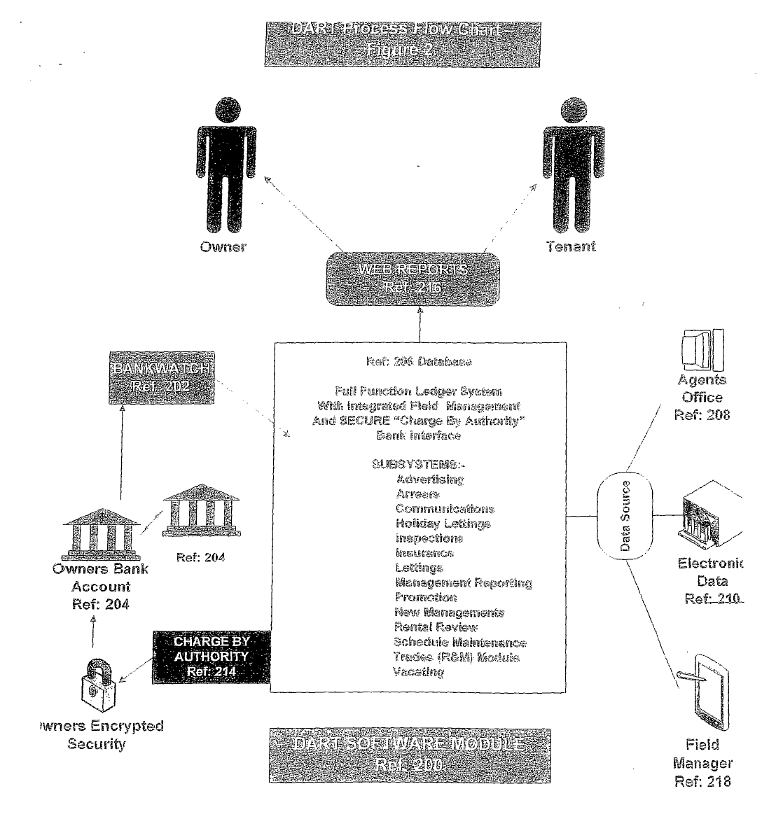

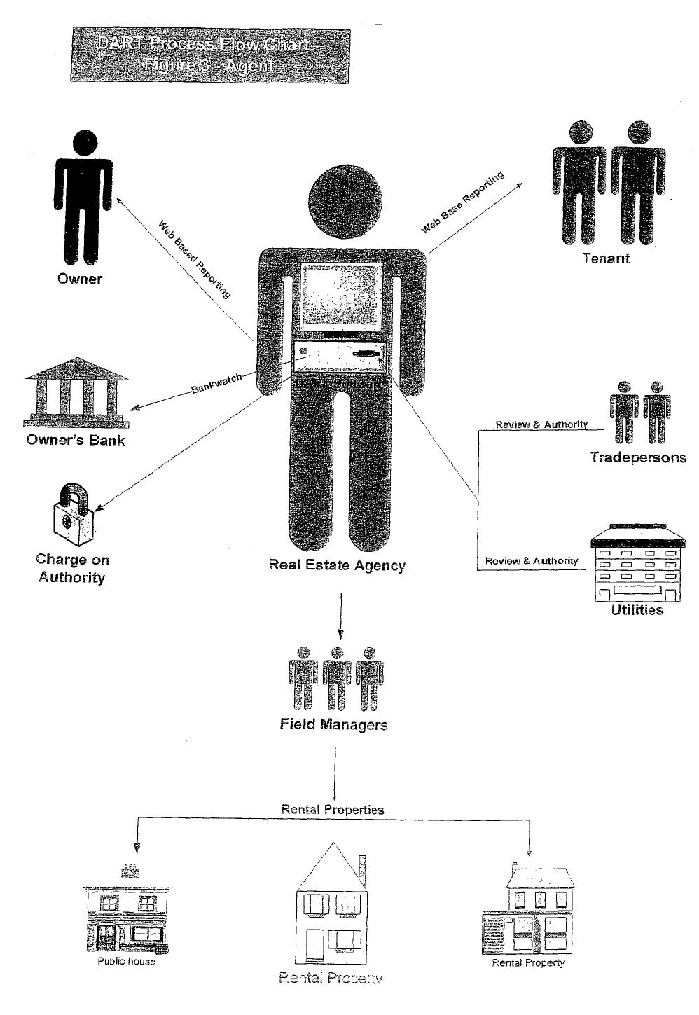

FIG. 1 is a computing system arranged to execute an embodiment of the present invention;

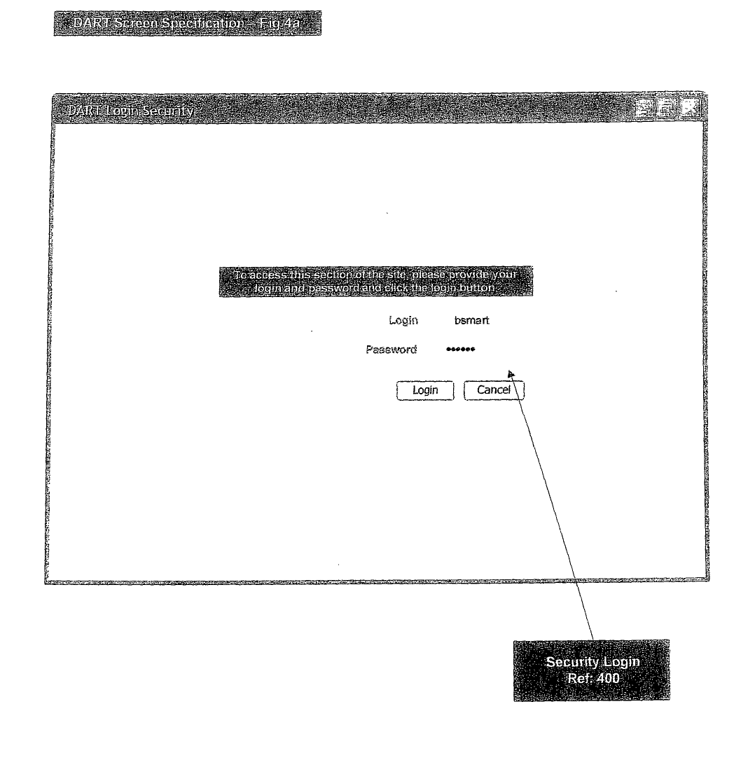

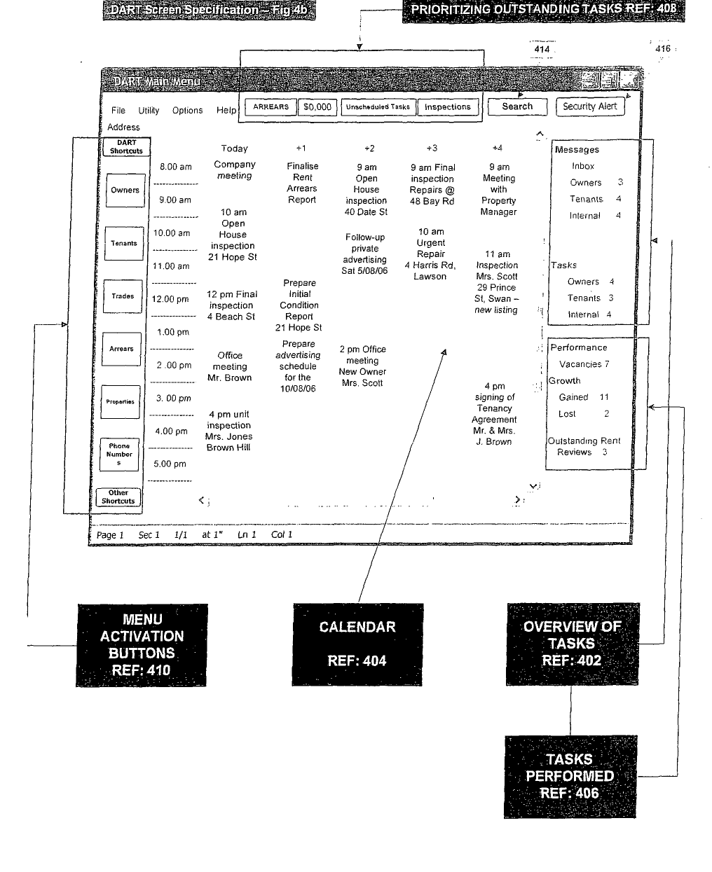

FIG. 2 is a process flow chart illustrating the operation of an embodiment of the present invention;

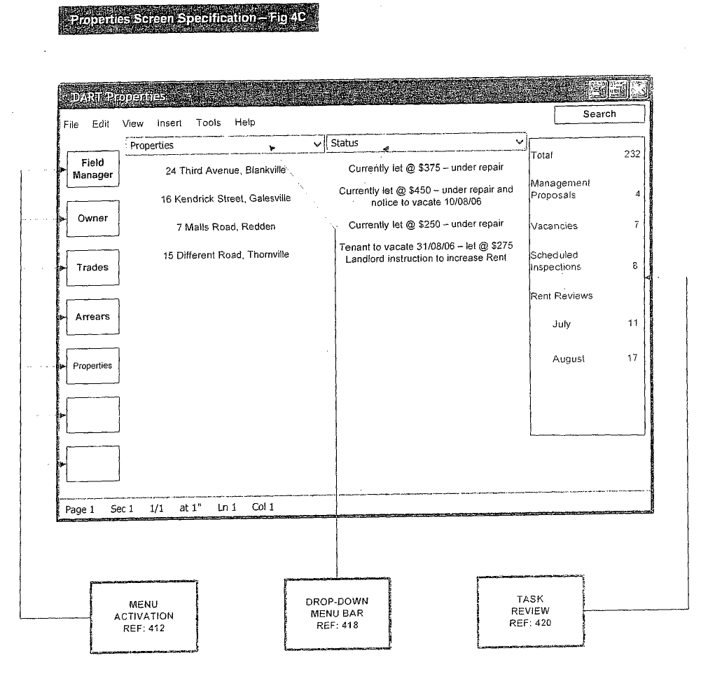

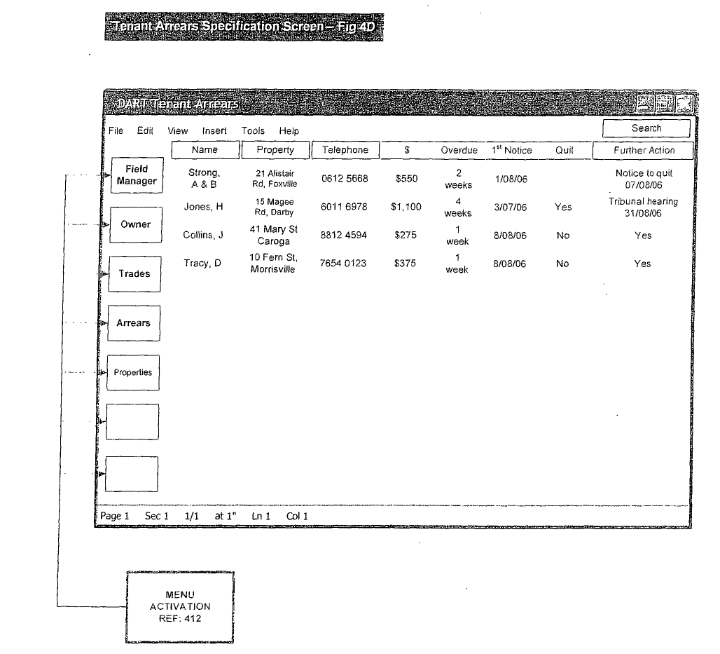

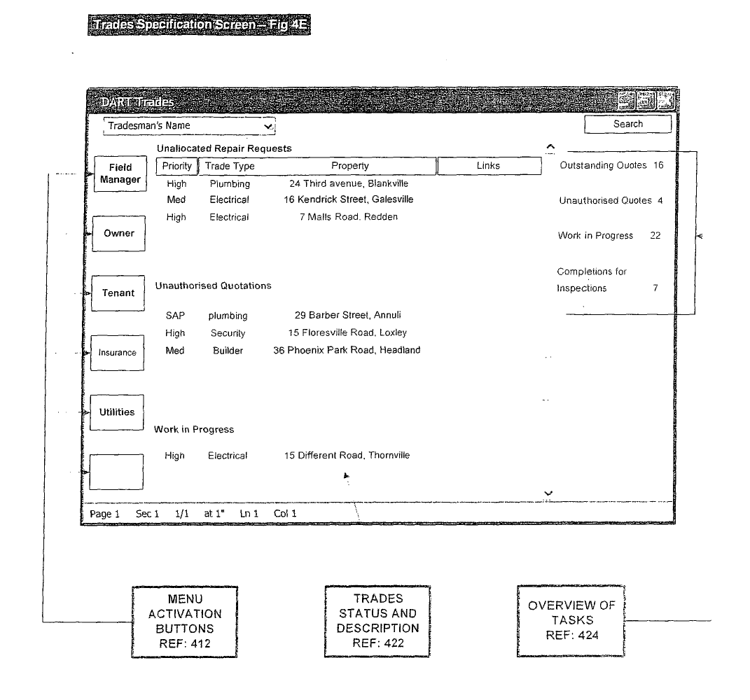

FIG. 3 is a diagram illustrating the interaction between different parties who interact with an embodiment of the present invention;

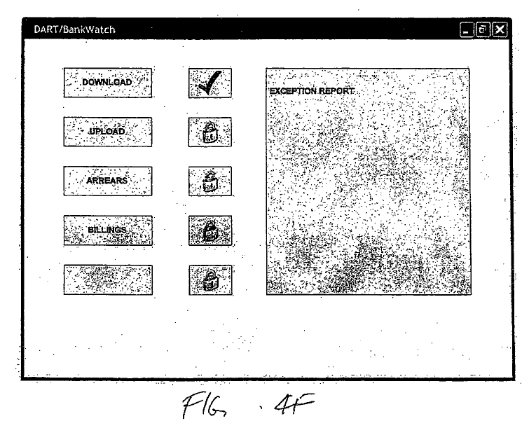

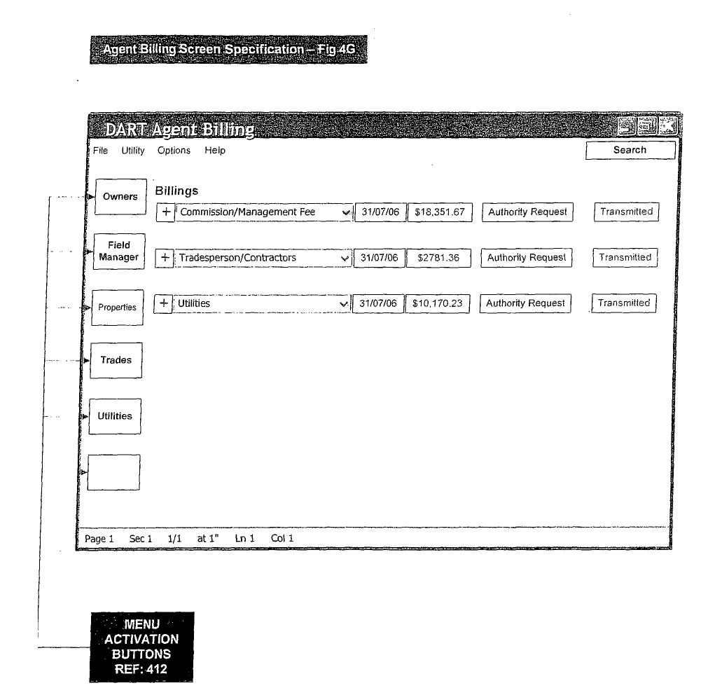

FIGS. 4a to 4h are screenshots of a user interface in accordance with an embodiment of the present invention; and

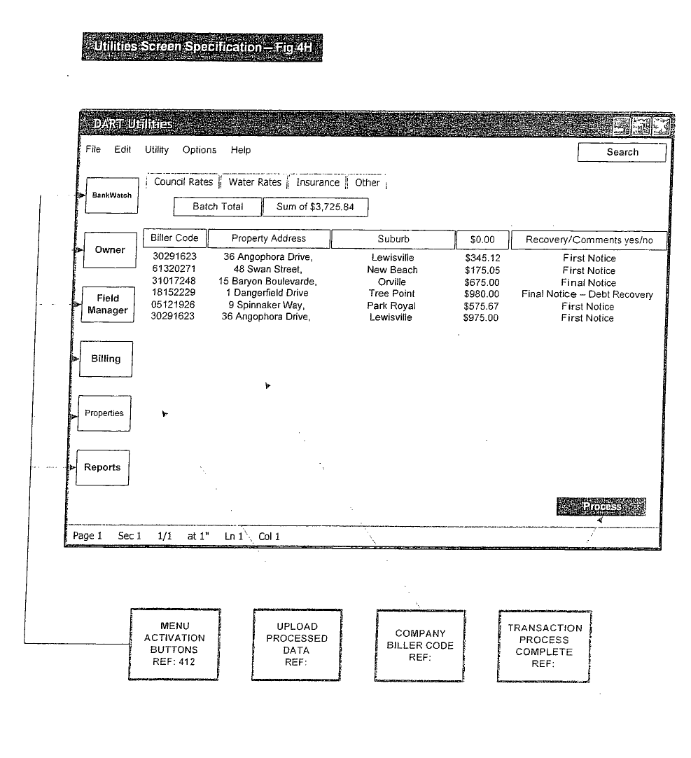

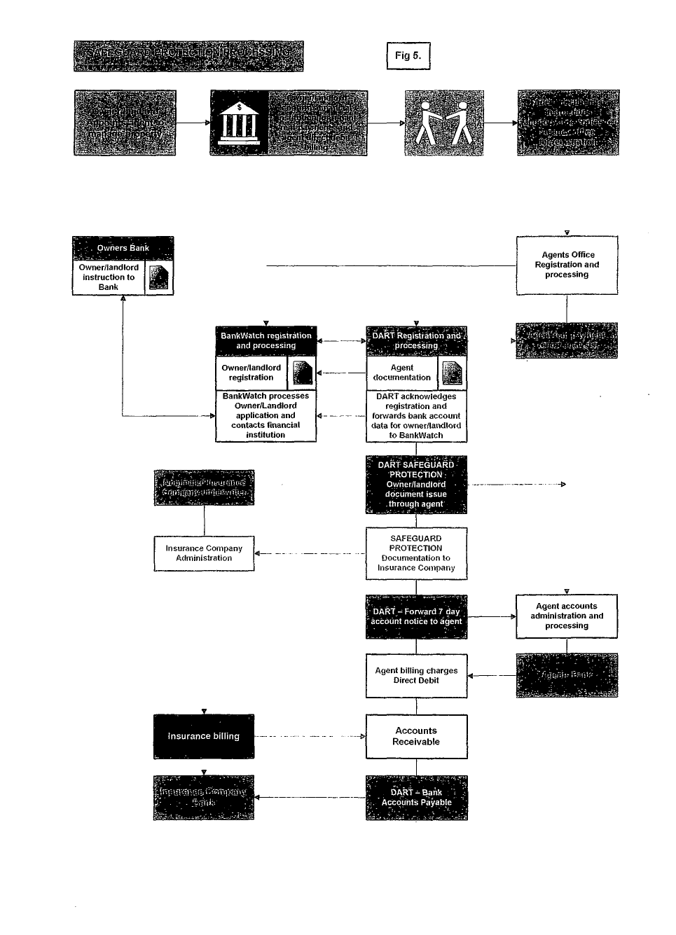

FIG. 5 is a flowchart depicting a method in accordance with an embodiment of the present invention.

### DETAILED DESCRIPTION OF A SPECIFIC EMBODIMENT

The present invention, in a specific embodiment, provides a system and method for managing rental properties and rental income, without the need for an agent to set up, operate or control a trust account. However, whilst the agent does not hold a trust account, the agent continues to be capable of performing their regular management duties with respect to a property, such as:
determine whether rental income has been received in a timely manner;
keep records with regard to the receipt of rental income;
liaise with both the tenant and the owner in the case where repairs are required to the property;
preserve an audit trail should any queries be made by the owner and/or other interested third parties; and
pay for goods and/or services by direct debit authority to the owner's account.

These tasks are enabled by providing a software application which allows the agent to view information regarding an account owned and operated by the property owner. The Agent may also have direct debit authority to remove funds for an amount which has been preauthorised by the owner. That is, the agent may also have direct debit authority over the account, but not operating authority over the account.

In order to assist in the embodiment of the present invention, a property owner sets up an account in their own name. The account would have the following facilities:
(i) a nominated credit line;
(ii) authority for the Agent to withdraw funds under set limits;
(iii) the ability to be accessed remotely via a network, such as the Internet or via a mobile communications device, such as a mobile telephone; and
(iv) optionally, a hard copy statement facility.

The owner provides the account details to the agent, and allows the agent to view transactions carried out with respect to the account, but does not allow the agent to access funds directly without the owner's authorisation. Such an arrangement may be facilitated by both technical means (e.g. an authorisation means controlled by the financial institution, which prevents the agent from performing transactions), and/or by non-technical means (e.g. a contractual arrangement between the agent and the property owner).

On renting or leasing a property, the agent asks the tenant to pay rent into the owner's account. It will be understood that the payment may be made in any way, including over the counter payment, electronic (e.g. Internet, Mobile Banking Technology or direct debit) or any other suitable method. As the agent may view the transactions carried out with respect to the owner's account, the agent can determine whether the tenant is paying their rent in a timely manner.

The information may be accessed by an appropriate software application, which may also include other functionality to assist in the operation of an agent's practice.

At FIG. 1 there is shown a schematic diagram of a computing system 100 suitable for use with an embodiment of the present invention. The computing system 100 may be used to execute applications and/or system services such as a rental property management system in accordance with an embodiment of the present invention. The computing system 100 preferably comprises a processor 102, read-only memory (ROM) 104, random access memory (RAM) 106, and input/output devices such as disk drives 108, keyboard 110, mouse 112, display 114, printer 116, and communications link 118. The computer includes programs that may be stored in RAM 106, ROM 104, or disk drives 108 and may be executed by the processor 102. The communications link 118 connects to a computer network such as the Internet but may be connected to a telephone line, an antenna, a gateway or any other type of communications link. Disk drives 108 may include any suitable storage media, such as, for example, floppy disk drives, hard disk drives, CD ROM drives or magnetic tape drives. The computing system 100 may use a single disk drive 108 or multiple disk drives. The computing system 100 may use any suitable operating systems, such as Windows™ or Unix™.

It will be understood that the computing system described in the preceding paragraphs is illustrative only, and that an embodiment of the present invention may be executed on any suitable computing system, with any suitable hardware and/or software.

In one embodiment, the present invention is implemented as a software application 120 which interacts with a database 122, wherein both the software application and the database are arranged to be executable on the computing system 100.

Referring to FIG. 2, the software application 200 (equivalent to 120 in FIG. 1) includes a module 202 (in the described embodiment, a “bankwatch” module) arranged to interrogate a bank or financial institution server which contains details regarding an account 204 held solely by the owner 205 (or a legal person under the control of the owner). The module 202 obtains transaction information 206 from the account 204. The transaction information is saved in a database 206 (equivalent to database 122 shown in FIG. 1).

The agent (not shown) is capable of viewing transaction data and is also capable of inputting other relevant data via any one of a number of channels, including via a personal computer or terminal 208 located in the agent's office, via direct electronic data transfer 210 or via a portable wireless device 212.

The data may be communicated via any suitable communication network, including the Internet, a proprietary network (e.g. a private connection between different offices of an organisation), a wireless network, such as an 802.11 standard network, or a telecommunications network (including but not limited to a telephone line, a GSM or CDMA mobile phone network, or a microwave link).

It will be understood that the agent may be able to interact with the software application or system solely through a wireless device, such as a tablet PC or a PDA (personal digital assistant). The software application may include or interface with any number of available technologies, including fingerprint security, Voice over Internet Protocol (VoIP) communication capabilities, text-to-speech or speech-to-text enablement, mobile communication capabilities, such as the ability to send or receive SMS (short message service), MMS (multimedia message service), GPS (global positioning system) capabilities, and/or any other technology which allows the software application to operate as a mobile application.

It will also be understood that in certain instances, the software may incorporate Smart Card technology or RFID technology to allow the agent to be uniquely identified.

The Smart Card or RFID may be used as an identification means, either in conjunction with or in addition to a traditional ‘login’ (i.e. username and password) procedure.

The software application may also include the ability to execute documents (such as Leases) via secure signature procedures.

The software application may also include, or interface with, voice recognition software, to allow a user to navigate or enter information into the software application by providing verbal commands.

Each of the features described above may be included in particular embodiments of the invention, as required for a particular user or customer.

In the embodiment described herein, the software application also includes a “charge by authority” module 214. This is akin to a credit card or EFTPOS facility, which allows an agent, upon appropriate authorisation from the owner, to withdraw funds from the owner's bank account, for any suitable purpose, such as to pay a tradesperson to carry out repairs on the property, or as payment for services rendered in managing the property.

The authority to pay is a facility which is set up through a different provision in the agreement between the agent and the owner and will generally only allow for direct debit authority, not operating authority. It may include terms which limit the amount of funds which may be withdrawn during any given time period. Funds required over the agreed limit may require specific authorisation. Moreover, it may be possible for the owner to nominate a different account from which to withdraw funds (such as a credit card), if appropriate.

In a web enabled version of the software application, web reports 216 may be generated for both the owner 205 and the tenant 218. These reports may include the following fields:
Owners
(i) current month and historic income and expenditure;
(ii) current and historic letting information;
(iii) current and historic inspection reports including, photographs;
(iv) current and historic trades quotes and accompanying data including photographs; and
(v) arrears history.
Tenants
(i) payment history;
(ii) repair request history;
(iii) rental increase history;
(iv) rent review schedule; and
(v) inspection reports as they pertain to tenant issues.

The owner may also be able to access the web based software application to authorise repairs, provide special instructions, etc.

The property management system may include further modules which assist the agent in their management of properties and/or the general management of administrative work common to all businesses.

For example, the system may include modules which provide functions such as:
Advertising: The system may include a module which includes a mailing list which is arranged to send emails or letters to all owners and/or tenants located in the database.
Alternatively, the module may automatically advertise properties which have become vacant, by uploading details of the vacated properties to a real estate web site, or automatically print out an advertisement for use in the agent's window or in a publication. For example, the module may:
   build a file of properties for let or to be available for let based on variable database parameters;
   attach digital photographs;
   attach advertising history including dollar spend;
   prepare and electronically submit and receive copy and quotations;
   accept third party electronic charges for processing;
   accept and action pre programmed budget constraints and auto cyclic advertising of similar profile vacancies; and
   automatically alert existing tenants (or other clients located on a database) of the newly available properties, either by sending an electronic message, such as an email or message to their PC or a portable communications device (such as a mobile telephone).
Arrears: The system may be arranged to automatically compile a list of tenants who have not paid their rent by the due date.
Holiday Letting The system may include a sub-module arranged to manage properties which are only available for rent during certain times of the year. When the properties are not available, the sub-module may stop the request of information from bank accounts (as it is not necessary to check accounts when it is known that no rental income is expected).
Inspections: The system may prompt agents to carry out periodic inspections of properties.
Insurance: The system may prompt agents to renew appropriate insurance (such as building or property insurance) on behalf of the owner.
Management Reporting The system may include a module which allows a managing agent to review the performance of agency staff, or review the status of the business at a glance. For example, how many tenants are in arrears, whether inspections are being carried out on a timely basis, etc.
Review: The system may include a review module which prompts the agent to review rental rates paid by a tenant.
Scheduled Maintenance: The system may include a module which prompts the agent to authorise or carry out periodic maintenance, such as fire inspections, air conditioning and other plant maintenance. The system may also include a module that sends data to a tradesperson, so that a tradesperson may know when, where and what type of repair is to be carried out on a property. In more detail, the system may allow a Subcontract Tradesperson to be provided with an integrated Repairs and Maintenance system that will enable, but not be limited to:
(i) The receipt of instructions from a Property Manager.
(ii) The preparation of a quotation for required works, inclusive of:
   standard costing and materials data base;
   digital photographic input;
   job schedule monitoring;
   transmission of quote and receipt of authorisation; and
   job scheduling/diary interface.
(iii) Access to Historic Repair and Maintenance data for the property.
(iv) Billing and Electronic Tax Invoicing.
(v) Notification of Authorisation of Payment.
Vacating: The system may remind an agent that a property is being vacated, to prompt the agent to re-advertise the property. Alternatively, the vacating module may prompt the agent to carry out an inspection to determine whether any appreciable wear and tear has occurred.

Referring to FIG. 3, it is shown that the system in accordance with an embodiment of the present invention allows the agent to manage a property in a transparent and efficient manner, whilst allowing the owner with direct and immediate control over the rental income paid by a tenant.

Providing such a system ameliorates the need for a real estate agent to maintain a trust account and also ameliorates the need for the agent to carry out the procedures which are required when maintaining a trust account. This preferably streamlines the agent's practice and reduces their overhead costs, thereby allowing the agent to service more clients (property owners) in a timely and efficient manner.

Benefits also accrue to the property owner. As the rental income is paid directly into the owner's account, the owner has instant access to the income, as they do not need to wait for the agent to release their income from a trust account.

Furthermore, as the owner receives the income at first instance, they will benefit from the immediate investment of funds payable to their investment portfolio, or alternatively, the owner can more quickly reduce the property mortgage.

In other words, the owner has more control over the management of the property, as they have more control of the rental income at first instance.

The advantages of at least an embodiment of the present invention may be made by referring to the comparison table below:

| | | EMBODIMENT OF THE |
|---|---|---|
| | PRIOR ART | INVENTION |
| Tenant Pays | Into Agent's | Into Owner's |
| | Trust account | account |
| Payments Made on | Deducted from | Debited from |
| Behalf of Owner | Trust moneys | Owner's account |
| (e.g. repairs, | | |
| rates etc., as | | |
| authorised) | | |
| Agent's Charges | Deducted from | Debited from |
| | Trust moneys | Owner's account |
| Petties and | Deducted from | No charge |
| Postage | Trust moneys | |
| End of Month | Transfer to Owner | N/A |
| Disbursement | | |
| Owners Statement | Posted to Owner | On website, by |
| | | email or from |
| | | Bank Statement |

Importantly, however, the immediate payment of rent into the owner's account obviates many of the concerns and legal problems associated with holding a trust account. If an employee of a real estate agent mistakenly releases funds from a trust account, there may be legal consequences, or at the very least, extra time and resources utilised in correcting the mistake. Such issues are obviated with an embodiment of the present invention, as there is no longer a need to hold funds in trust.

Correspondingly, the possibility of a real estate agent or a property owner being defrauded is also greatly reduced, as there is no need for the agent to hold a trust account which holds a potentially large sum of funds.

As the software application includes a number of safeguards against fraud and operator error, it also has the surprising advantage of potentially reducing the agent's liability, and therefore the insurance premium payable by the agent. It is possible that such a system would induce insurers to lower the premium payable for running a real estate agent business, as it can be demonstrated that the risk posed by negligence and fraud is ameliorated by the software application. Moreover, the software application, in some jurisdictions, may be bundled with appropriate insurance, as an incentive for an agent to purchase the software application. This advantage is explained in more detail later.

The system is also compatible with the growing concern over consumer rights in many Western countries. By removing the need for a trust account system, the property owner is directly paid the rental monies owed, and therefore the relationship between the tenant, the agent and the owner becomes more transparent.

The issues of fraud, error and responsibility may be further managed by providing a number of different permission levels.

For example, the system may include a facility which only allows a sub-set of operators (such as the principal agents) to approve the direct debit of funds from an owner's account.

This will limit the ability of employees of the agent to effect large and possibly untraceable transfers of funds to or from bank accounts. Employees may be able to compile a list of transfers to be effected, but the final authorisation for such transfers may vest with the agent. The agent may be required, for example, to log into the system using a password (or other appropriate authorisation means, such as a biometric scan) to review all scheduled transfers. Once satisfied that the transfers are appropriate, the agent may then authorise the transfer by any appropriate means, such as by attaching an electronic signature to the transfers, or simply choosing a “Transfer Now” option.

By providing this additional step, the agent can potentially reduce the number of errors, fraudulent attempts to remove money from bank accounts, and other undesirable events.

In the embodiment described, there is also provided an intuitive user interface for a software application in accordance with FIGS. 4a to 4h. In the following example, the software application will be referred to as “DART”.

FIG. 4a is a screenshot of a login screen 400. In the embodiment described herein, DART requires each user to identify themselves before access to the system is allowed. This allows an audit trail to be created, which preferably decreases the incidence of undesirable behaviour, such as fraud, and also allows operator error to be more easily identified and corrected.

FIG. 4b is a screenshot of the “main” screen of the DART software application. This is the screen normally encountered by a user (i.e. agent) when they first log in. The DART main screen is arranged to provide three types of information to a user. The first is to provide an instant overview of all outstanding and/or pending tasks. This information is provided in part by the overview of tasks column 402, which provides an overview of the outstanding tasks. This may include the number of unanswered emails, the total number of tasks outstanding, the total number of tasks to be performed in a day, etc.

More comprehensive information is provided by the weekly (or other time period) calendar 404. The calendar 404 allows a user to easily review the tasks they should or must complete within a given time period.

The second type of information provided by DART is information regarding past and current performance of the user. The main screen provides the user with an overview of their progress to date by displaying a series of metrics, generally indicated at area 406. The metrics 406 assist a user in prioritising various outstanding tasks and also allow a user to place more emphasis on tasks that may have been neglected.

In more detail, the area 406 may display a number of metrics related to overall performance over a given time period. This may include performance metrics such as the total number of vacant properties, the total growth in the user's personal business and the number of tenants in arrears.

For example, if a user has a large number of vacancies, then they may concentrate on attempting to let (find tenants for) the vacant properties. Alternatively, if they have a large number of tenants with outstanding rent due, they may concentrate on meeting with the tenants to ensure that outstanding rent is paid in a timely manner.

The prioritisation of tasks is assisted by the buttons 408 which appear on the main screen. These are radio buttons which allow the user to gain more information about a particular aspect of their allocated tasks. For example, if the user wishes to see more detail about tenants who are in arrears, they can click on the “arrears” button, which takes them to another screen with more information.

The third type of information is provided by the menu buttons 410 which are arranged generally along the left hand side of the screen. The buttons 410 provide shortcuts which allow the user to “jump” to another screen which contains more in-depth information. Shortcuts advantageously allows the user to intuitively navigate DART without requiring any in-depth training. For example, if the user wants to see a list of all tenants, they simply press the “tenants” button.

The buttons which appear along the left menu can change, depending on which screen is being viewed at any particular time. For example, in FIG. 4a, which is a main menu screen, the shortcuts include “owners”, “tenants”, “trades”, “arrears”, “properties” and “phone numbers”. However, in FIGS. 4c and 4d, for example, the menu changes, to show the shortcuts “Field Manager”, “Owner”, “Trades”, “Arrears” and “Properties” (412). See also FIGS. 4d, 4e, 4g and 4h (412) for examples of how the buttons vary depending on the screen.

The dynamic nature of the shortcuts ensures that the user can access relevant in-depth information which is associated with the screen that they are currently viewing.

Utilising such a menu system also facilitates the input of information when the user is using a mobile device, such as a PDA (personal digital assistant) or mobile telephone, as such systems are easier to navigate by button pressing, rather than requiring a user to attempt to use pull down menus.

There are also provided two buttons 414 and 416, which each provide a defined function. Button 414 is a search button, to allow the user to search for any type of information. This may be useful when the user has a client name, but does not know, for example, whether the client is a tenant or an owner.

Button 416 is a security alert button. This button is particularly important in situations where the user is providing information “in the field” via a mobile device. The security alert allows the user to instantly communicate with the office, or with a law enforcement agency, should they find themselves in a dangerous situation. For example, the user may be visiting a tenant who becomes violent. In this event, the user may push the security alert button to call for help. In DART, the security alert sends a message to a monitoring service (akin to an alarm monitoring service), who then takes steps to contact the user to verify the safety of the user. If the user cannot be contacted, then an appropriate law enforcement agency is contacted.

In another embodiment, the security alert may be activated when the user inputs a predetermined key combination, similar to a PIN (personal identification number) code.

It will be understood that the security alert could be implemented in a number of ways. In one example, when the security alert is pushed, the user may be placed in instant, live communication utilising ‘push to talk’ mobile technology. In another example, the user may also carry a separate panic button, which is arranged to alert security in the event of an accident or of an emergency. Such variations and modifications are within the scope of the present embodiment.

The system also includes a “help” procedure, where any illegal or erroneous attempts to input information will invoke a help procedure, to guide the user through the correct procedure. The help procedure is provided in addition to the standard help menus, which may be accessible through a pull down or button menu.

Various subsidiary screens are shown at FIGS. 4c to 4h. FIG. 4c is a screenshot of a “properties” screen, which lists all the properties overseen by the user. It includes dropdown menus 418, which allow a user to sort properties by any suitable criteria. The properties screen also includes a task review section 420, which provides more in-depth, but “at a glance” information on the performance of the user.

FIG. 4d shows a list of arrears, i.e. tenants who are currently behind in their rent.

FIG. 4e is a screenshot of the trades screen, which provides a list of repair requests. It is akin to the properties screen of FIG. 4c, in that it provides a status section 422 with information on whether quotations have been sought, and whether repairs are a work in progress or have been completed (i.e. a status section), and an overview section 424, which provides metrics which allow the user to instantly and intuitively see what areas need work. Such information is invaluable in managing properties successfully, as both owners and tenants wish to have properties repaired in a speedy, efficient and cost-effective manner.

FIG. 4f is a screenshot of the “bankwatch” screen, which allows the user to check the status of owners' bank accounts. This information may then be imported into DART, and rent arrears may be identified.

FIG. 4g is a screenshot of an agent billing screen, which allows the user to authorise monetary transactions to appropriate third parties, such as for the payment of agent fees, the payment of tradespeople/contractors and the payment of utilities.

Similarly, FIG. 4h is a screenshot of a utilities screen for a property, detailing the utilities paid on the property. The screen is divided into a number of sections, including the menu activation buttons 412.

Each of these screens have been designed to provide information in a concise, efficient manner.

Referring now to FIG. 5, there is shown a flowchart depicting the information and monetary flows actioned by a software application in accordance with an embodiment of the present invention.

In particular, it is instructive to refer generally to area 500, which outlines an additional aspect of the embodiment described herein. As alluded to earlier, the embodiment lowers the risk of legal action for negligence or fraud, because the software ameliorates the need for a trust account, while also providing a very comprehensive audit trail, including checks and balances, to minimise the risk of negligence or fraud.

In doing so, the embodiment lowers the risk profile of the real estate agent, which in turn should lower agent's professional indemnity insurance premium.

The embodiment takes this concept one step further by automatically allocating and paying a portion of the agent service fee towards an insurance premium, held in the name of the building owner, to protect against accidental or deliberate damage by a tenant (or guests, other third parties, natural disasters, etc). The insurance may also cover rental default, if a tenant leaves without notice, does not pay the rent, or if rental income is lost due to damage to the property.

In the embodiment, the property owner insurance is offered as an integrated service. A portion of the premium charged by the real estate agent is set aside and sent to the insurance company to cover the property owner's insurance. By integrating this service with the DART software application, the property owner receives a comprehensive property management service, plus insurance against possible fraud, negligence, accidental damage and rent default, and is only charged one fee per month (or other appropriate time period). In addition, the property owner remains fully informed of the status of the property, due to the comprehensive reporting available through DART.

Similarly, insurance may also be offered to the Agent by allocating and paying a further portion of the Agent Management fee towards an insurance premium to cover acts of negligence or fraud. Paying an insurance premium fee per transaction becomes very attractive to an insurer, as the risk of negligence or fraud is proportional, in part, to the number of transactions made by a real estate agent.

The combination of these features makes the service particularly attractive to the property owner.

It will be understood that while the embodiment described herein may be operated as a stand alone software application residing on a real estate agent's server or computing system, the embodiment may also be operated by a separate entity that provides the software application as a “service” to a number of real estate agents, for an appropriate fee.

Referring again to FIG. 5, such a system is exemplified generally at area 502. The DART system may be offered as a web-based application which is accessible by a plurality of separate real estate agents. On the processing of each transaction carried out by a real estate agent, a small amount may be deducted from the agent's bank account, as a “usage” charge. Of course, for convenience, money may only be deducted from the agent's account once a predetermined change has been reached.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-34. (canceled)

35. A system for use by an agent when managing rental income derived from a property, comprising, an interrogation module arranged to receive information regarding a third party financial institution account controlled by an owner of the property, and utilise the information to verify that rental income has been paid by a tenant of the property, and a module arranged to interact with the financial institution account, to withdraw a fee from a bank account under the control of the property owner.

36. The system in accordance with claim 35, wherein the funds that can be withdrawn from the account are limited to a predetermined amount.

37. The system in accordance with claim 35, further comprising a remote access module arranged to allow access to the system from a remote location.

38. The system in accordance with claim 37, wherein the system may be accessed by the owner or the tenant of the property.

39. The system in accordance with claim 37, further comprising a report compiling module arranged to provide a summary of rental income paid by the tenant to the owner.

40. The system in accordance with claim 35, further comprising a database arranged to store information pertaining to the payment of rental income.

41. The system in accordance with claim 40, further comprising a module arranged to interact with the database to store information pertaining to the rental property.

42. The system in accordance with claim 40, further comprising a module arranged to interact with the database to forward information in the database pertaining to the rental property to other users of the system.

43. The system in accordance with claim 40, further comprising a scheduling module arranged to prompt a user to perform an action with regard to the rental property.

44. The system in accordance with claim 43, the scheduling module being arranged to prompt the user to perform at least one of the activities selected from the group including inspecting the property, paying insurance due on the property, reviewing the rental paid for the property, carrying out scheduled maintenance, and contacting a tenant who has not paid rental income by the due date.

45. The system in accordance with claim 41, further comprising a management module arranged to interact with the database to compile reports pertaining to the ongoing management of the property or a plurality of properties.

46. The system in accordance with claim 45, wherein the fee management module apportions a percentage of the fee for the payment of an insurance premium.

47. The system in accordance with claim 46, wherein the insurance premium is utilised to pay for a property owner's insurance policy.

48. The system in accordance with claim 35, wherein the system is a web server.

49. The system in accordance with claim 35, wherein the system is a standalone application.

50. The system in accordance with claim 35, further comprising a user interface including a first defined area which is capable of displaying at least one task to be performed by a user, a second defined area which is capable of displaying at least one metric relevant to the user's past performance, and a third area which is capable of displaying at least one user control, arranged to allow the user to navigate to vary the information displayed in the first or second area.

51. A method of managing rental income utilising a computing system, comprising the steps of accessing a financial institution account controlled by an owner of a property, verifying that the rental income has been paid by a tenant of the property, whereby the access and verification is performed by an agent of the owner, and interacting with the financial institution account to withdraw finds from the accounts wherein the amount is withdrawn is a fee.

52. The method in accordance with claim 51, comprising the further step of limiting the funds that can be withdrawn from the account to a predetermined account.

53. The method in accordance with claim 52, comprising the further step of providing remote access to allow access to the computing system from a remote location.

54. The method in accordance with claim 53, whereby the system may be accessed by the owner or the tenant.

55. The method in accordance with claim 53, comprising the further step of compiling report including a summary of rental income paid by the tenant to the owner.

56. The method in accordance with claim 53, comprising the further step storing information pertaining to the payment of rental income in a database.

57. The method in accordance with claim 56, further comprising the step of interacting with the database to store information pertaining to the rental property.

58. The method in accordance with claim 56, further comprising the step of interacting with the database to forward information in the database pertaining to the rental property to other users of the system.

59. The method in accordance with claim 56, further comprising the step of prompting a user to perform an action with regard to the rental property.

60. The method in accordance with claim 59, whereby the user is prompted to perform at least one of the activities selected from the group including inspecting the property, paying insurance due on the property, reviewing the rental paid for the property, carrying out scheduled maintenance, and contacting a tenant who has not paid rental income by the due date.

61. The method in accordance with claim 57, comprising the further step of interacting with the database to compile reports pertaining to the ongoing management of the property or a plurality of properties.

62. The method in accordance with claim 61, comprising the further step of apportioning a percentage of the fee for the payment of an insurance premium.

63. The method in accordance with claim 62, whereby the insurance premium is utilised to pay for a property owner's insurance policy.

64. The method in accordance with claim 51, comprising the further step of operating the computing system as a web service.

65. A property management software application arranged, when loaded onto a computing system, to carry out the method steps of claim 51.

66. A computer readable medium providing a computer software application in accordance with claim 65.

67. A user interface for a software application, comprising a first defined area which is capable of displaying at least one task to be performed by a user, a second defined area which is capable of displaying at least one metric relevant to the user's past performance, and a third area which is capable of displaying at least one user control, arranged to allow the user to vary the information displayed in the first or second area.

68. A system for use in managing rental income derived from a property, comprising, an interrogation module arranged to receive information regarding a financial institution account controlled by an owner of the property, and verify that rental income has been paid by a tenant of the property, wherein the system is accessible by an agent for the owner of the property.
